(19) United States
(12) Patent Application Publication
(10) Pub. No.: US 2011/0149932 A1
(43) Pub. Date: Jun. 23, 2011

(54) ZIGBEE GATEWAY AND MESSAGE IDENTIFICATION METHOD OF THE SAME

(75) Inventors: Hyun Hak KIM, Daejeon (KR); Tae Wook Heo, Daejeon (KR); Jong Arm Jun, Daejeon (KR)

(73) Assignee: Electronics and Telecommunications Research Institute, Daejeon (KR)

(21) Appl. No.: 12/887,918

(22) Filed: Sep. 22, 2010

(30) Foreign Application Priority Data
Dec. 21, 2009 (KR) 10-2009-0128034

(51) Int. Cl. H04L 12/56; H04W 4/00

(52) U.S. Cl. 370/338

(57) ABSTRACT

A ZigBee gateway includes: an IP network communication unit supporting communications with an IP network; a ZigBee network communication unit supporting communications with a ZigBee network; and a message processing unit generating a forwarding entry containing a service request ID and a transaction sequence ID corresponding to a service request message, when the service request message is received from the IP network, and performing a forwarding operation between the service request message and a response message transmitted from the ZigBee network in response to the service request message, by referring to the forwarding entry.

### CROSS-REFERENCE TO RELATED APPLICATIONS

This application claims the priority of Korean Patent Application No. 10-2009-0128034 filed on Dec. 21, 2009, in the Korean Intellectual Property Office, the disclosure of which is incorporated herein by reference.

### BACKGROUND OF THE INVENTION

1. Field of the Invention

The present invention relates to a ZigBee gateway and a message identification method of the same, and more particularly, to a ZigBee gateway which is capable of stably guaranteeing the identity of a message between a service request and a response even in the case that the response is repetitively and continuously generated for a single service request, and a message identification method of the same.

2. Description of the Related Art

ZigBee refers to technology standardized for low transmission speed, low-power communications, and a data network with high efficiency and was developed to efficiently use short-distance communication.

A ZigBee gateway is a device which receives commands or service requests to be transferred to ZigBee networks or devices from external Internet protocol-based host applications (IPHAs) and then transfers responses to the external IPHAs. The ZigBee functionality may be accessed and used from outside through the ZigBee gateway.

The ZigBee gateway device (ZGD) standard and the ZigBee stack standard have been established so that the ZigBee gateway may communicate with a ZigBee network through a ZigBee stack. As the ZigBee stack standard, a ZigBee cluster library (ZCL) standard is used.

Three standards, the ZGD standard, the ZigBee stack, and the ZCL standard may be used in order to read or write a specific attribute from or to a device within the ZigBee network through a ZCL command, and to receive a report on a specific event. Furthermore, a ZigBee device object (ZDO) command may be issued so as to manage ZigBee devices or search for a ZigBee device and a service provided by the ZigBee device. Furthermore, the participation of ZigBee devices in the ZigBee network may be initialized, and security operations of the ZigBee devices may be controlled.

In general, the ZigBee gateway is a relatively large-scale system capable of performing IP communication, and manages service request IDs, which guarantee the uniqueness for requests from an IP network, as 32-bit variables. Therefore, in the ZGD standard, the ZigBee gateway is defined in that it identify 2³² different requests, such that the service requests received from the IP network and responses to be transmitted to the IP network are reliably identified by IP hosts.

On the other hand, ZigBee devices are relatively small-scale systems, and the ZigBee stack standard and the ZCL standard are defined on the basis of low power and low speed such that the sequence IDs of ZCL or ZDO transactions through the ZigBee wireless communication are managed as 8-bit variables. Therefore, the ZigBee stack standard and the ZCL standard define that only 2⁸ different ZCL and ZDO transactions may be identified with each other.

Accordingly, the ZigBee gateway identifies the command ID to which a response transferred to the gateway is a response as a request ID requiring a 32-bit uniqueness value.

However, the ZigBee stack standard identifies the transaction to which a given response is a response as an 8-bit transaction sequence ID variable. Therefore, the response of the ZigBee wireless communications may not be reliably identified with the request from the IP network.

Furthermore, the ZigBee stack standard recommends the use of a method for sequentially increasing the transaction sequence ID, as a ‘Shall’ statement, and the number of transaction sequence IDs is relatively small (256). Therefore, the likelihood that different responses will have the same transaction sequence ID increases.

For example, a user making a requester of the IP network may issue a ZCL command to request a specific ZigBee device to periodically respond or continuously respond to changes in a specific event. When such a periodic or continuous response of the ZigBee device continues while 256 (2⁸) different requests from the IP network are processed, the transaction IDs may overlap each other. In that case, the ZigBee gateway cannot identify the request to which the corresponding response is a response.

According to the above-described existing standards, a response which may be identified is provided to a request from an IP network requesting a single-time response. However, an unreliable response is inevitably provided to a request from an IP network requesting repetitive and continuous responses, due to the overlapping transaction IDs.

### SUMMARY OF THE INVENTION

An aspect of the present invention provides a ZigBee gateway which is capable of stably guaranteeing the identity of a message between a service request and a response even in the case that the response is repetitively and continuously generated for a single service request, and a message identification method of the same.

According to an aspect of the present invention, there is provided a ZigBee gateway including: an IP network communication unit supporting communications with an IP network; a ZigBee network communication unit supporting communications with a ZigBee network; and a message processing unit generating a forwarding entry containing a service request ID and a transaction sequence ID corresponding to a service request message, when the service request message is received from the IP network, and performing a forwarding operation between the service request message and a response message transmitted from the ZigBee network in response to the service request message, by referring to the forwarding entry.

The message processing unit may include a function of maintaining the forwarding entry when the response message is one of multiple response messages, and deleting the forwarding entry when the response message is a one-time response message or a final response message of multiple response messages.

The message processing unit may include: a forwarding table management section generating the forwarding entry when the service request message is received and transmitted, and deciding whether or not to delete the forwarding entry when the response message is received and transmitted; and a message conversion section attaching a transaction sequence ID to the service request message so as to transmit the service request message to the ZigBee network when the service request message is received, and attaching a service request ID to the response message by referring to the forwarding entry so as to transmit the response message to the IP network when the response message is received.

The message conversion section may acquire a forwarding entry corresponding to the response message by using the transaction sequence ID and service respondent information contained in the response message.

The ZigBee gateway may further include a forwarding table storing and managing a service request ID, a transaction sequence ID, service requester information, and service respondent information for guaranteeing the uniqueness of a service request message for each forwarding entry.

According to another aspect of the present invention, there is provided a network system including: one or more IP hosts positioned in an IP network and generating and outputting a service request message; a ZigBee gateway generating a forwarding entry containing a service request ID and a transaction sequence ID corresponding to the service request message when the service request message is received, and performing a forwarding operation between the service request message and a response message corresponding to the service request message by referring to the forwarding entry; and one or more ZigBee devices positioned in a ZigBee network and generating and outputting the response message corresponding to the service request message.

The ZigBee gateway may include: an IP network communication unit supporting communication with the one or more IP hosts; a ZigBee network communication unit supporting communication with the one or more ZigBee devices; a message processing unit generating the forwarding entry containing the service request ID and the transaction sequence ID corresponding to the service request message, when the service request message is received, and performing a forwarding operation between the service request message and the response message, which correspond to each other, by referring to the forwarding entry; and a forwarding table storing and managing a service request ID, a transaction sequence ID, service requester information, and service respondent information for guaranteeing the uniqueness of a service request message for each forwarding entry.

The message processing unit may include a function of maintaining the forwarding entry when the response message is one of multiple response messages, and deleting the forwarding entry when the response message is a one-time response message or a final response message of multiple response messages.

The message processing unit may include: a forwarding table management section generating the forwarding entry when the service request message is received and transmitted, and deciding whether or not to delete the forwarding entry when the response message is received and transmitted; and a message conversion section attaching a transaction sequence ID to the service request message so as to transmit the service request message to the ZigBee network when the service request message is received, and attaching a service request ID to the response message by referring to the forwarding entry corresponding to the service request message so as to transmit the response message to the IP network when the response message is received.

The message conversion section may acquire a forwarding entry corresponding to the response message by using the transaction sequence ID and service respondent information contained in the response message.

The ZigBee device may generate a response message corresponding to the service request message, attach the transaction sequence ID contained in the service request message to the response message, and transmit the response message to the ZigBee gateway.

According to another aspect of the present invention, there is provided a message identification method of a ZigBee gateway including: receiving a service request message transmitted from an IP network; generating a forwarding entry containing a service request ID, a transaction sequence ID, service requester information, and service respondent information corresponding to the service request message, while transmitting the service request message to a ZigBee network; acquiring the forwarding entry by using the transaction ID and the service respondent information contained in a response message, when the response message corresponding to the service request message is received from the ZigBee network; and transmitting the response message to the IP network by referring to the forwarding entry.

The method may further include maintaining the forwarding entry when the response message is one of multiple response messages, and deleting the forwarding entry when the response message is a one-time response message or a final response message of multiple response messages.

The generating of the forwarding entry may include: generating the service request ID corresponding to the service request message, generating the forwarding entry containing the service request ID and the service requester information contained in the service request message, and registering the forwarding entry in a forwarding table; generating the transaction sequence ID corresponding to the service request message, attaching the transaction sequence ID to the service request message, and transmitting the service request message to the ZigBee network; and additionally storing the service respondent information contained in the transaction sequence ID and the service request message into the forwarding entry.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a network including a ZigBee gateway according to an embodiment of the present invention;

FIG. 2 is a detailed configuration diagram of the ZigBee gateway according to the embodiment of the present invention;

FIG. 3 is a diagram showing a forwarding table according to the embodiment of the present invention; and

FIG. 4 is a flow chart explaining a message identification method of the ZigBee gateway according to another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

Furthermore, when it is described that one component ‘includes’ another component, it means that the one component does not exclude yet another component, but may include yet another component.

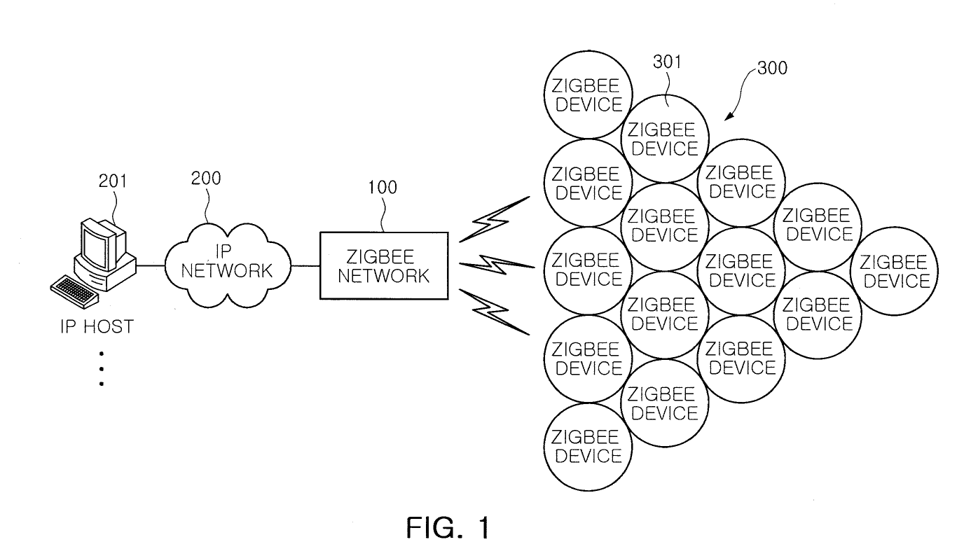

FIG. 1 is a diagram illustrating a network including a ZigBee gateway according to an embodiment of the present invention.

Referring to FIG. 1, the ZigBee gateway 100 according to the embodiment of the present invention is positioned between an IP network 200 and a ZigBee network 300 and serves to transmit a service request from an IP host 201 positioned in the IP network 200 to the ZigBee network 300 or transmit a response from a ZigBee device 301 positioned in the ZigBee network 300 to the corresponding IP host 201.

The IP host 201 generates various service request messages based on the ZigBee cluster library (ZCL), and transmits the generated service request messages to the ZigBee gateway 100.

At this time, the service request messages may include information about the service requester, information about the service respondent, and command information about the request command. The information about the service requester may include a source address of the IP host having transmitted the service request. The information about the respondent may include a destination address, a cluster ID, and an attribute ID of the target ZigBee device so as to respond to the service request. The command information may include a command type, a command ID, and a command execution condition.

The ZigBee gateway 100 receives the service request message from the IP host 201 through the IP network 200, and generates a service request ID and a transaction sequence ID corresponding to the service request message. Furthermore, the ZigBee gateway 100 generates a forwarding entry including the service request ID, the transaction sequence ID, and forwarding information contained in the service request message, and registers the generated forwarding entry in a forwarding table. The forwarding information may include the source address, the destination address, the cluster ID and the attribute ID of the target ZigBee device. Simultaneously, the ZigBee gateway 100 attaches the transaction sequence ID to the service request message and then transmits the service request message to the ZigBee device 301.

The ZigBee device 301, receiving the service request message transmitted through the ZigBee gateway 100, generates a response message in response to the service request message including the transaction sequence ID, and transmits the generated response message to the ZigBee gateway 100.

At this time, the response message may include the destination address of the IP host having transmitted the service request message, the source address and the cluster ID and attribute ID of the target ZigBee device transmitting the response message, and command information in which the service response result is described in detail. The command information may include a command type, a command ID, and a command execution result.

Then, the ZigBee gateway 100 extracts the transaction sequence ID, the cluster ID and attribute ID of the target ZigBee device, which are included in the response message transmitted from the ZigBee device 301, and searches for a relevant forwarding entry in the forwarding table by using the IDs. The ZigBee gateway 100 determines the address of the IP host 201 requiring the response message by referring to the searched—for forwarding entry, and acquires a service request ID corresponding to the response message. Furthermore, the ZigBee gateway 100 substitutes the transaction sequence ID included in the response message with the acquired service request ID, and then transmits the response message to the address of the corresponding IP host 201.

Subsequently, the ZigBee gateway 100 analyzes the command information included in the response message and checks as to whether the corresponding response message is one of multiple response messages or not. As a result of the checking, when the corresponding response message is one of multiple response messages, the relevant forwarding entry is continuously maintained. On the other hand, when the corresponding response message is a one-time response message or a final response message of the multiple response messages, the relevant forwarding entry is deleted.

The ZigBee gateway 100 according to the embodiment of the present invention uses the same forwarding entry to perform a forwarding operation, although a plurality of response messages are generated at multiple times by one service request message. Therefore, the ZigBee gateway 100 prevents uncertainty from occurring due to the overlapping transaction sequence ID between the service request message and the response message, which makes it possible to stably guarantee the identity between one service request message and a plurality of response messages corresponding to the service request message.

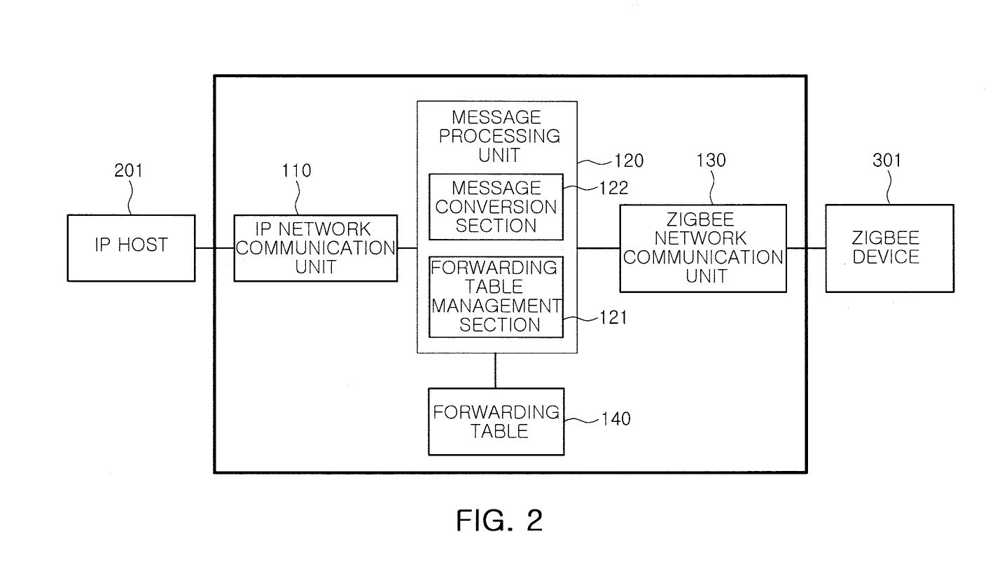

FIG. 2 is a detailed configuration diagram of the ZigBee gateway according to the embodiment of the present invention.

Referring to FIG. 2, the ZigBee gateway 100 according to the embodiment of the present invention includes an IP network communication unit 110, a message processing unit 120, a ZigBee network communication unit 130, and a forwarding table 140. The message processing unit 120 includes a forwarding table management section 121 and a message conversion section 122.

The IP network communication unit 110 supports communications between the IP host 201 positioned in the IP network 200 and the ZigBee gateway 100, based on the ZGD standard. More specifically, when a service request message is transmitted from the IP host 201, the IP network communication unit 110 converts the service request message into a data format recognizable by the message processing unit 120 and then transfers the converted service request message to the message processing unit 120. Furthermore, the IP network communication unit 110 converts a response message outputted from the message processing unit 120 into a data format transmittable through the IP network 200 and then transmits the response message to the IP host 201.

When the service request message is received, the forwarding table management section 121 generates a service request ID corresponding to the service request message, extracts service requester information, that is, a source address from the service request message, generates a forwarding entry including the service request ID and the service request information, and then registers the forwarding entry in the forwarding table 140. When a transaction sequence ID is generated by the message conversion unit 122, the forwarding table management section 121 additionally stores the generated transaction sequence ID and service respondent information contained in the service request message in the corresponding forwarding entry. The service respondent information may include a destination address and a cluster ID and an attribute ID of a target ZigBee device.

On the other hand, when the response message is received, a command ID and a command execution result of the response message are analyzed to check whether the response message is one of multiple response messages or not. When the response message is one of multiple response messages, the relevant forwarding entry is continuously maintained. On the other hand, when the response message is a one-time response message or a final message of the multiple response messages, the relevant forwarding entry is deleted.

When the service request message is received, the message conversion section 122 generates a new transaction sequence ID, attaches the generated transaction sequence ID to the service request message, and then transfers the service request message to the ZigBee network communication unit 130 by referring to the forwarding entry corresponding to the service request message. Then, when a response message corresponding to the service request message is transmitted from the ZigBee network 300, the message conversion section 122 acquires a relevant forwarding entry by searching the forwarding table 140 through the transaction sequence ID included in the response message and the service respondent information including the source address and the cluster ID and attribute ID of the target ZigBee device. By referring to the acquired forwarding entry, the message conversion section 122 substitutes the transaction sequence ID included in the response message with a service request ID, and then transmits the response message to the corresponding IP host.

The ZigBee network communication unit 130 supports the communications between the ZigBee device 301 positioned in the ZigBee network 300 and the ZigBee gateway 100, based on the ZigBee standard. More specifically, the ZigBee network communication unit 130 converts the service request message outputted from the message processing unit 120 into a data format transmittable through the ZigBee network 300, and transmits the converted service request message to the ZigBee device 301. When the response message transmitted from the ZigBee device 301 is received, the ZigBee network communication unit 130 converts the response message into a data format recognizable by the message processing unit 120 and transfers the converted response message to the message processing unit 120.

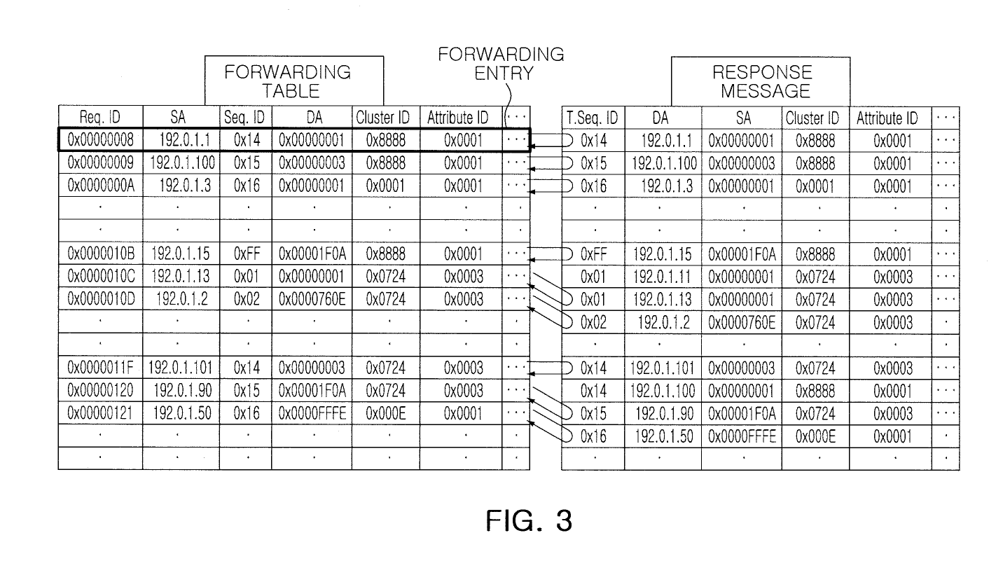

FIG. 3 is a diagram showing the forwarding table 140. Referring to FIG. 3, the forwarding table 140 stores and manages a service request ID (Request ID), service requester information including a source address (SA) included in a service request message, a transaction sequence ID (T.Seq.ID), service respondent information including a destination address (DA) contained in the service request message, a cluster ID (Cluster ID) and an attribute ID (Attribute ID) of a target ZigBee device for a forwarding entry corresponding to each of the service request messages.

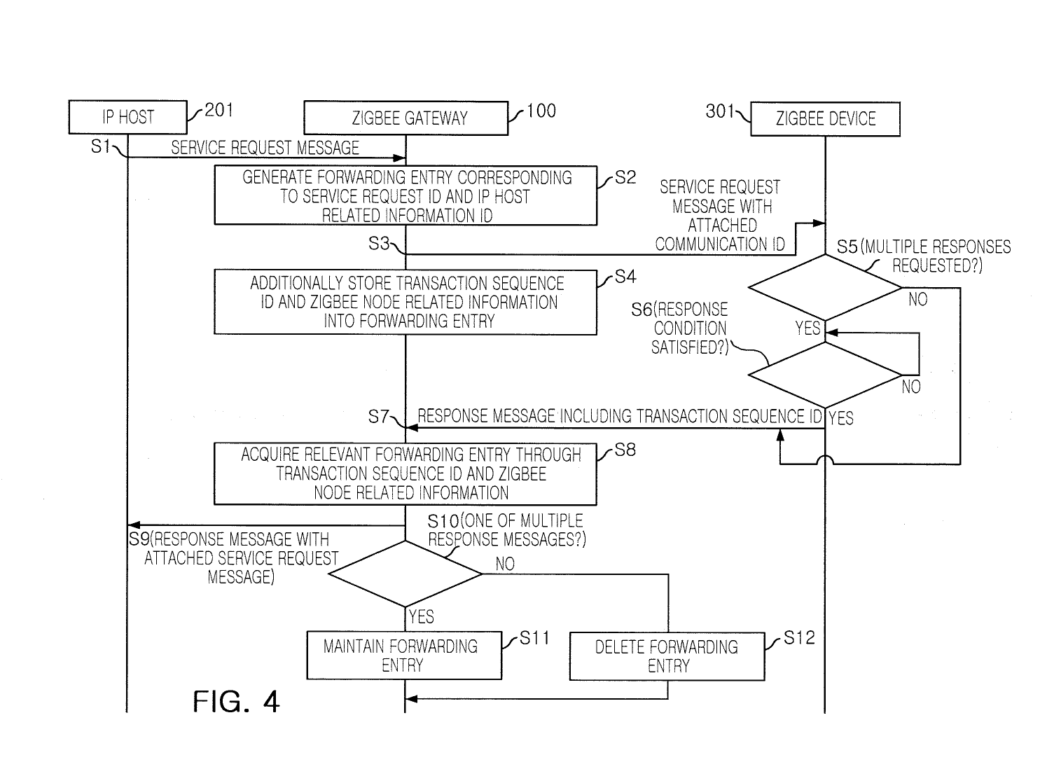

FIG. 4 is a flow chart explaining a message identification method of the ZigBee gateway according to the embodiment of the present invention.

First, the IP host 201 generates and outputs a service request message (S1).

The ZigBee gateway 100 receiving the service request message of the IP host 210 generates a service request ID (for example, 0x00000008) for guaranteeing the identity of the service request message and extracts a source address (for example, 192.0.1.1) included in the service request message. Then, the ZigBee gateway 100 generates a forwarding entry including the service request ID and the source address and registers the generated forwarding entry in the forwarding table 140 (S2).

Subsequently, the ZigBee gateway 100 generates a transaction sequence ID (0x14) for transmitting the service request message, attaches the generated transaction ID to the service request message, and then transmits the service request message to the ZigBee device 301(S3).

The ZigBee gateway 100 additionally stores the transaction sequence ID generated through the operation S3 and service respondent information included in the service request message into the forwarding entry generated through the operation S2 (S4). The service respondent information may include a destination address (for example, 0x00000001), a cluster ID (for example, 0x8888) and an attribute ID (for example, 0x0001) of the target ZigBee device.

The ZigBee device 301 receives the service request message transmitted through the ZigBee gateway 100 and analyzes command information (in particular, a command type and a command ID) included in the service request message to check whether the IP host 201 is requesting multiple responses or not (S5).

As a result of the operation S5, when it is determined that the IP host 201 is requesting multiple responses, the ZigBee device 301 additionally analyzes the command information (in particular, a command execution condition) included in the service request message to determine the number of responses, the response period, or the change state of a event which is to be detected. Whenever the response condition is satisfied (S6), the ZigBee device 301 repetitively generates a response message including the transaction sequence ID contained in the service request message, and transmits the generated response message to the ZigBee gateway 100 (S7).

On the other hand, when it is determined that the IP host 201 is requesting a one-time response, the ZigBee device 301 generates a response message including the transaction sequence ID only one time, and transmits the generated response message to the ZigBee gateway 100 (S7).

The ZigBee gateway 100 receives the response message, and acquires the relevant forwarding entry by searching the forwarding table 140 through the transaction sequence ID (for example, 0x14), the source address (for example, 0x00000001) and the cluster ID (for example, 0x8888) and the attribute ID (for example, 0x0001) of the target ZigBee device, which are included in the response message (S8).

The ZigBee gateway 100 acquires the service request ID (for example, 0x00000008) for guaranteeing the identity and the address (for example, 192.0.1.1) of the IP host requiring the response message from the forwarding entry acquired through the operation S8. Then, the ZigBee gateway 100 substitutes the transaction sequence ID included in the response message with the service request ID, and transmits the response message to the address of the IP host (S9).

The ZigBee gateway 100 analyzes the command information included in the response message to check whether the corresponding response message is one of the multiple response messages or not (S10) at the same time when the operation S9 is performed.

When the response message is one of the multiple response messages, the ZigBee gateway 100 continuously maintains the forwarding entry acquired through the operation S8 (S11). On the other hand, when the response message is a one-time response message or a final message of the multiple response messages, the ZigBee gateway 100 deletes the forwarding entry acquired through the operation S8 (S12).

According to the embodiments of the present invention, the ZigBee gateway and the message identification method of the same may perform a forwarding operation by using the same forwarding entry, even though a plurality of response messages are generated by one service request message. Therefore, it is possible to stably guarantee the identity thereof, even in the case that responses are repetitively or continuously generated by one service request.

While the present invention has been shown and described in connection with the exemplary embodiments, it will be apparent to those skilled in the art that modifications and variations can be made without departing from the spirit and scope of the invention as defined by the appended claims.

What is claimed is:

1. A ZigBee gateway comprising:
an IP network communication unit supporting communications with an IP network;
a ZigBee network communication unit supporting communications with a ZigBee network; and
a message processing unit generating a forwarding entry containing a service request ID and a transaction sequence ID corresponding to a service request message, when the service request message is received from the IP network, and performing a forwarding operation between the service request message and a response message transmitted from the ZigBee network in response to the service request message, by referring to the forwarding entry.

2. The ZigBee gateway of claim 1, wherein the message processing unit further comprises a function of maintaining the forwarding entry when the response message is one of multiple response messages, and deleting the forwarding entry when the response message is a one-time response message or a final response message of multiple response messages.

3. The ZigBee gateway of claim 2, wherein the message processing unit comprises:
a forwarding table management section generating the forwarding entry when the service request message is received and transmitted, and deciding whether or not to delete the forwarding entry when the response message is received and transmitted; and
a message conversion section attaching a transaction sequence ID to the service request message so as to transmit the service request message to the ZigBee network when the service request message is received, and attaching a service request ID to the response message by referring to the forwarding entry so as to transmit the response message to the IP network when the response message is received.

4. The ZigBee gateway of claim 3, wherein the message conversion section acquires a forwarding entry corresponding to the response message by using the transaction sequence ID and service respondent information contained in the response message.

5. The ZigBee gateway of claim 1, further comprising a forwarding table storing and managing a service request ID, a transaction sequence ID, service requester information, and service respondent information for guaranteeing the uniqueness of a service request message for each forwarding entry.

6. A network system comprising:
one or more IP hosts positioned in an IP network and generating and outputting a service request message;
a ZigBee gateway generating a forwarding entry containing a service request ID and a transaction sequence ID corresponding to the service request message when the service request message is received, and performing a forwarding operation between the service request message and a response message corresponding to the service request message by referring to the forwarding entry; and
one or more ZigBee devices positioned in a ZigBee network and generating and outputting the response message corresponding to the service request message.

7. The network system of claim 6, wherein the ZigBee gateway comprises:
an IP network communication unit supporting communications with the one or more IP hosts;
a ZigBee network communication unit supporting communications with the one or more ZigBee devices;
a message processing unit generating the forwarding entry containing the service request ID and the transaction sequence ID corresponding to the service request message, when the service request message is received, and performing a forwarding operation between the service request message and the response message, which correspond to each other, by referring to the forwarding entry; and
a forwarding table storing and managing a service request ID, a transaction sequence ID, service requester information, and service respondent information for guaranteeing the uniqueness of a service request message for each forwarding entry.

8. The network system of claim 7, wherein the message processing unit further comprises a function of maintaining the forwarding entry when the response message is one of multiple response messages, and deleting the forwarding entry when the response message is a one-time response message or a final response message of multiple response messages.

9. The network system of claim 8, wherein the message processing unit comprises:
a forwarding table management section generating the forwarding entry when the service request message is received and transmitted, and deciding whether or not to delete the forwarding entry when the response message is received and transmitted; and
a message conversion section attaching a transaction sequence ID to the service request message so as to transmit the service request message to the ZigBee network when the service request message is received, and attaching a service request ID to the response message by referring to the forwarding entry corresponding to the service request message so as to transmit the response message to the IP network when the response message is received.

10. The network system of claim 9, wherein the message conversion section acquires a forwarding entry corresponding to the response message by using the transaction sequence ID and service respondent information contained in the response message.

11. The network system of claim 9, wherein the ZigBee device generates a response message corresponding to the service request message, attaches the transaction sequence ID contained in the service request message to the response message, and transmits the response message to the ZigBee gateway.

12. A message identification method of a ZigBee gateway, comprising:
receiving a service request message transmitted from an IP network;
generating a forwarding entry containing a service request ID, a transaction sequence ID, service requester information, and service respondent information corresponding to the service request message, while transmitting the service request message to a ZigBee network;
acquiring the forwarding entry by using the transaction ID and the service respondent information contained in a response message, when the response message corresponding to the service request message is received from the ZigBee network; and
transmitting the response message to the IP network by referring to the forwarding entry.

13. The message identification method of claim 12, further comprising maintaining the forwarding entry when the response message is one of multiple response messages, and deleting the forwarding entry when the response message is a one-time response message or a final response message of multiple response messages.

14. The message identification method of claim 12, wherein the generating of the forwarding entry comprises:
generating the service request ID corresponding to the service request message, generating the forwarding entry containing the service request ID and the service requester information contained in the service request message, and registering the forwarding entry in a forwarding table;
generating the transaction sequence ID corresponding to the service request message, attaching the transaction sequence ID to the Service request message, and transmitting the service request message to the ZigBee network; and
additionally storing the service respondent information contained in the transaction sequence ID and the service request message into the forwarding entry.
